(19) United States
(12) Patent Application Publication
(10) Pub. No.: US 2025/0165189 A1
(43) Pub. Date: May 22, 2025

(54) BIT STRING ARBITER COMPONENTS

(71) Applicant: Micron Technology, Inc., Boise, ID (US)

(72) Inventor: Leonid Minz, Beer Sheva (IL)

(21) Appl. No.: 18/948,878

(22) Filed: Nov. 15, 2024

Related U.S. Application Data
(60) Provisional application No. 63/602,066, filed on Nov. 22, 2023.

(51) Int. Cl. G06F 3/06

(52) U.S. Cl. CPC G06F 3/0659; G06F 3/0604; G06F 3/0688

(57) ABSTRACT

A method includes receiving a plurality of bit strings to be written to respective memory banks of a memory device, writing a first bit string among the plurality of bit strings to a first rank of a first memory bank among the plurality of memory banks during a first timing period, and writing a second bit string among the plurality of bit strings to a second rank of the first memory bank among the plurality of memory banks during a second timing period.

### PRIORITY INFORMATION

This Application claims the benefit of U.S. Provisional Application No. 63/602,066, filed on Nov. 22, 2023, the contents of which are incorporated herein by reference.

### TECHNICAL FIELD

Embodiments of the disclosure relate generally to memory sub-systems, and more specifically, relate to bit string arbiter components.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The present disclosure will be understood more fully from the detailed description given below and from the accompanying drawings of various embodiments of the disclosure.

FIG. 1 illustrates an example computing system that includes a memory sub-system in accordance with some embodiments of the disclosure.

FIG. 2 illustrates a memory system for bit string arbiters in accordance with some embodiments of the disclosure.

FIG. 3 illustrates a method for performing arbitration of bit strings in accordance with some embodiments of the disclosure.

FIG. 4 is a block diagram of an example computer system in which embodiments of the disclosure may operate.

### DETAILED DESCRIPTION

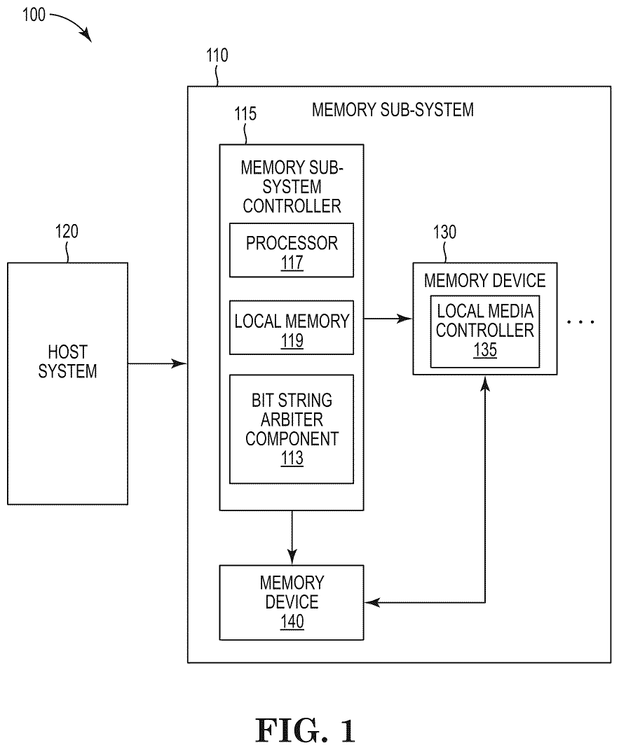

Aspects of the present disclosure are directed to arbitration for writing bit strings to a memory bank, in particular to memory sub-systems that include a bit string arbiter component. A memory sub-system can be a storage system, storage device, a memory module, or a combination of such. An example of a memory sub-system is a storage system such as a solid-state drive (SSD). Examples of storage devices and memory modules are described below in conjunction with FIG. 1, et alibi. In general, a host system can utilize a memory sub-system that includes one or more components, such as memory devices that store data. The host system can provide data to be stored at the memory sub-system and can request data to be retrieved from the memory sub-system.

A memory device can be a non-volatile memory device. One example of non-volatile memory devices is a negative-and (NAND) memory device (also known as flash technology). Other examples of non-volatile memory devices are described below in conjunction with FIG. 1. A non-volatile memory device is a package of one or more dice. Each die can consist of one or more planes. Planes can be grouped into logic units (LUN). For some types of non-volatile memory devices (e.g., NAND devices), each plane consists of a set of physical blocks. Each block consists of a set of pages. Each page consists of a set of memory cells (“cells”). A cell is an electronic circuit that stores information. A block hereinafter refers to a unit of the memory device used to store data and can include a group of memory cells, a word line group, a word line, or individual memory cells. For some memory devices, blocks (also hereinafter referred to as “memory blocks”) are the smallest area that can be erased. Pages cannot be erased individually, and only whole blocks can be erased.

Each of the memory devices can include one or more arrays of memory cells. Depending on the cell type, a cell can be written to in order to store one or more bits of binary information, and has various logic states that correlate to the number of bits being stored. The logic states can be represented by binary values, such as “0” and “1”, or combinations of such values. There are various types of cells, such as single-level cells (SLCs), multi-level cells (MLCs), triple level cells (TLCs), and quad-level cells (QLCs). For example, a SLC can store one bit of information and has two logic states.

Some NAND memory devices employ a floating-gate architecture in which memory accesses are controlled based on a relative voltage change between the bit line and the word lines. Other examples of NAND memory devices can employ a replacement-gate architecture that can include the use of word line layouts that can allow for charges corresponding to data values to be trapped within memory cells based on properties of the materials used to construct the word lines.

In general, memory devices can include one or more memory banks. As used herein, a “memory bank” refers to a physical unit of storage or a logical unit of storage controlled by a bank controller. The bank controller can be utilized to control or manage the flow of data between a host device and the memory resources associated with the memory bank(s). The bank controller can receive commands indicative of read and/or write operations from multiple master command decoders to provide bit strings to a particular memory resource of the memory bank (e.g., to a particular set of physical addresses and/or logical addresses of a memory bank and/or to storage locations of a particular memory bank in embodiments in which multiple memory banks are provided). Since there are a plurality of master command decoders sending bit strings to the bank controller, multiple bit strings can be provided to the same bank controller simultaneously or substantially simultaneously. In addition, providing bit strings to a particular portion of the memory bank during sequential cycles can cause errors to the particular portion, such as a particular memory resource, of the memory bank(s).

In some previous approaches, an arbiter (e.g., a bank arbiter) was utilized to ensure that bit strings received from the plurality of master command decoders would be provided to memory resources of the memory bank without errors. The arbiter(s) could also be utilized to ensure that sequential bit strings were not provided to same memory resource of the memory bank. As used herein, an “arbiter,” or “bank arbiter” given the context of the disclosure, is a component of a memory device that can determine an order for requests to be passed to a memory resource. In general, the arbiter can follow particular rules (e.g., arbitration rules, etc.) for providing requests from a host to the bank controller. As used herein, “arbitration rules” can be a set of instructions for the arbiter on how to allocate writing and/or reading of bit strings to particular memory resources of one or more memory banks. In this way, the arbitration rules can be executed by the arbiter to ensure that errors do not occur when performing read or write operations involving the memory resources of the memory banks.

In some previous approaches, the quantity of memory banks can be increased relative to the quantity of master command decoders. For example, the quantity of memory banks can be greater than the quantity of master command decoders to allow a request from the quantity of master command decoders to be alternated to different memory banks. In this example, the arbiter can alternate requests to different memory banks to ensure that sequential requests are not provided to the same memory bank and/or provided to the same portion of memory resources of a particular memory bank. In these approaches, each of the quantity of memory banks can be utilized during alternate clock cycles such that an operation can be performed on a first memory bank during a first clock cycle, the first memory bank is not utilized during a second clock cycle, and the first memory bank can be utilized for a third clock cycle, etc. In this way, the arbiter can ensure that the first memory bank is not utilized during sequential clock cycles and/or that the first memory bank will have a sequential request performed, which could cause an error associated with the first memory bank. Similarly, in such examples, an operation may not be performed on a second memory bank during the first clock cycle, an operation can be performed on the second memory bank during a second clock cycle, and the second memory bank may not be utilized for a third clock cycle, etc.

These previous approaches can be more costly, for example, in terms of power consumption, latency, physical space consumed within a memory device, etc., since adding the quantity of memory banks can be relatively more costly compared to having fewer memory banks. In addition, these previous approaches can also have relatively lower bandwidth for the quantity of memory banks since each memory bank is utilized during alternate clock signals compared to a full bandwidth of being utilized during all clock signals. In this way, such previous approaches can have an increased cost and decreased performance compared to the embodiments of the present disclosure.

Aspects of the present disclosure address the above and other deficiencies by employing arbitration of writing of (and/or reading of) bit strings to memory banks based on memory ranks associated with the memory resources of the memory banks. As used herein, a “memory rank” refers to a subset of memory dice of a memory bank. For instance, the arbiter can send sequential bit strings to the same memory bank and utilize memory ranks associated with the memory bank. In this way, the memory bank can be utilized to perform a function during every clock signal and have full bandwidth compared to performing a function during alternate clock signals and therefore exhibiting half bandwidth performance. As described in more detail herein, aspects of the present disclosure therefore allow for the memory resources of the memory bank to be organized into a plurality of memory ranks. In such embodiments, the arbitration rules can be altered such that sequential bit strings can be provided to the same memory bank and during a first clock cycle a first bit string is provided to a first memory rank associated with the memory bank and during the second clock cycle a second bit string is provided to a second memory rank associated with the memory bank. In this way, the same memory bank can be utilized during sequential clock cycles and fewer memory banks are needed for the memory device, thereby providing an improvement to the overall functioning of a computing system in which embodiments of the present disclosure operate in comparison to the approaches described above.

FIG. 1 illustrates an example computing system that includes a memory sub-system in accordance with some embodiments of the disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a hybrid of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, server, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to different types of memory sub-system 110. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, and the like.

The host system 120 can include a processor chipset and a software stack executed by the processor chipset. The processor chipset can include one or more cores, one or more caches, a memory controller (e.g., an SSD controller), and a storage protocol controller (e.g., PCIe controller, SATA controller). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a serial advanced technology attachment (SATA) interface, a peripheral component interconnect express (PCIe) interface, universal serial bus (USB) interface, Fibre Channel, Serial Attached SCSI (SAS), Small Computer System Interface (SCSI), a double data rate (DDR) memory bus, a dual in-line memory module (DIMM) interface (e.g., DIMM socket interface that supports Double Data Rate (DDR)), Open NAND Flash Interface (ONFI), Double Data Rate (DDR), Low Power Double Data Rate (LPDDR), or any other interface. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the PCIe interface. The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include negative-and (NAND) type flash memory and write-in-place memory, such as three-dimensional cross-point (“3D cross-point”) memory device, which is a cross-point array of non-volatile memory cells. A cross-point array of non-volatile memory can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130, 140 can include one or more arrays of memory cells. One type of memory cell, for example, single-level cells (SLC) can store one bit per cell. Other types of memory cells, such as multi-level cells (MLCs), triple level cells (TLCs), quad-level cells (QLCs), and penta-level cells (PLC) can store multiple bits per cell. In some embodiments, each of the memory devices 130 can include one or more arrays of memory cells such as SLCs, MLCs, TLCs, QLCs, or any combination of such. In some embodiments, a particular memory device can include an SLC portion, a MLC portion, a TLC portion, a QLC portion, and/or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as three-dimensional cross-point arrays of non-volatile memory cells and NAND type memory (e.g., 2D NAND, 3D NAND) are described, the memory device 130 can be based on any other type of non-volatile memory or storage device, such as such as, read-only memory (ROM), phase change memory (PCM), self-selecting memory, other chalcogenide based memories, ferroelectric transistor random access memory (FeTRAM),ferroelectric random access memory (FeRAM), magneto random access memory (MRAM), Spin Transfer Torque (STT)-MRAM, conductive bridging RAM (CBRAM), resistive random access memory (RRAM), oxide based RRAM (OxRAM), negative-or (NOR) flash memory, and electrically erasable programmable read-only memory (EEPROM).

As described above, the memory components can be memory dice or memory packages that form at least a portion of the memory device 130. In some embodiments, the blocks of memory cells can form one or more “superblocks.” As used herein, a “superblock” generally refers to a set of data blocks that span multiple memory dice and are written in an interleaved fashion. For instance, in some embodiments each of a number of interleaved NAND blocks can be deployed across multiple memory dice that have multiple planes and/or pages associated therewith. The terms “superblock,” “block,” “block of memory cells,” and/or “interleaved NAND blocks,” as well as variants thereof, can, given the context of the disclosure, be used interchangeably.

The memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include digital circuitry with dedicated (i.e., hard-coded) logic to perform the operations described herein. The memory sub-system controller 115 can be a microcontroller, special purpose logic circuitry (e.g., a field programmable gate array (FPGA), an application specific integrated circuit (ASIC), etc.), or other suitable processor.

The memory sub-system controller 115 can be a processor 117 (e.g., a processing device) configured to execute instructions stored in a local memory 119. In the illustrated example, the local memory 119 of the memory sub-system controller 115 includes an embedded memory configured to store instructions for performing various processes, operations, logic flows, and routines that control operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory device 130 and/or the memory device 140. The memory sub-system controller 115 can be responsible for other operations such as wear leveling operations, garbage collection operations, error detection and error-correcting code (ECC) operations, encryption operations, caching operations, and address translations between a logical address (e.g., logical block address (LBA), namespace) and a physical address (e.g., physical block address, physical media locations, etc.) that are associated with the memory devices 130. The memory sub-system controller 115 can further include host interface circuitry to communicate with the host system 120 via the physical host interface. The host interface circuitry can convert the commands received from the host system into command instructions to access the memory device 130 and/or the memory device 140 as well as convert responses associated with the memory device 130 and/or the memory device 140 into information for the host system 120.

In some embodiments, the memory sub-system 110 can include a cache or buffer (e.g., DRAM) and address circuitry (e.g., a row decoder and a column decoder) that can receive an address from the memory sub-system controller 115 and decode the address to access the memory device 130 and/or the memory device 140. For instance, in some embodiments, the memory device 140 can be a DRAM and/or SRAM configured to operate as a cache for the memory device 130. In such instances, the memory device 130 can be a NAND.

In some embodiments, the memory device 130 includes local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, a memory device 130 is a managed memory device, which is a raw memory device combined with a local controller (e.g., local media controller 135) for media management within the same memory device package. An example of a managed memory device is a managed NAND (MNAND) device. The memory sub-system 110 can also include additional circuitry or components that are not illustrated.

The memory sub-system 110 can include a bit string arbiter component 113, which may be referred to in the alternative as a “controller,” “processor,” “processing device,” or variants thereof herein. Although not shown in FIG. 1 so as to not obfuscate the drawings, the bit string arbiter component 113 can include various circuitry to facilitate aspects of bit string arbitration, as detailed herein. In some embodiments, the bit string arbiter component 113 can include special purpose circuitry in the form of an ASIC, FPGA, state machine, and/or other logic circuitry that can allow the bit string arbiter component 113 to orchestrate and/or perform the operations described herein.

In some embodiments, the memory sub-system controller 115 includes at least a portion of the bit string arbiter component 113. For example, the memory sub-system controller 115 can include a processor 117 (processing device) configured to execute instructions stored in local memory 119 for performing the operations described herein. In some embodiments, the bit string arbiter component 113 is part of the memory sub-system 110, an application, or an operating system.

In a non-limiting example, an apparatus (e.g., the computing system 100) can include a bit string arbiter component 113. The bit string arbiter component 113 can be resident on the memory sub-system 110. As used herein, the term “resident on” refers to something that is physically located on a particular component. For example, the bit string arbiter component 113 being “resident on” the memory sub-system 110 refers to a condition in which the hardware circuitry that comprises the bit string arbiter component 113 is physically located on the memory sub-system 110. The term “resident on” can be used interchangeably with other terms such as “deployed on” or “located on,” herein.

The bit string arbiter component 113 can be configured to write a first bit string to a first memory rank of a first memory bank among the plurality of memory banks. As used herein, a “bit string” is a sequence of binary digits or bits. In some embodiments, a number of bits in the sequence is referred to as a length corresponding to a quantity of bits representative of a numerical value of said bit string. In some embodiments, the first bit string is received at the bit string arbiter component 113 and written to the first memory rank in response to a value given to the first bit string by the bit string arbiter component 113. As used herein, a “memory rank” generally refers to an area of a memory device or memory bank that comprises one or more memory dice (e.g., memory chips). The memory rank can be utilized to determine a particular order to write data to each of the memory ranks of the memory bank(s). That is, a plurality of memory ranks can each be assigned a separate or unique value (i.e., a “memory rank value”) that can be utilized to determine an order for writing bit strings to the plurality of memory ranks (i.e., the memory ranks of particular memory resources distributed across one or more memory dice that comprise constituent portions of the memory bank(s)).

As described further herein, the first bit string can be provided to a first bank controller by an arbiter (e.g., the bank arbiter component 113) to be written to the first memory rank of the first memory bank. In this embodiment, the first bank controller can be a controller that is designated to direct, control, or otherwise facilitate communication between a host 120 and the first memory bank. In this way, the first bank controller may not be designated or allowed to communicate with other memory banks than the first memory bank. In some embodiments, the first memory rank can include a first memory resource or first portion of memory of the first memory bank that includes a plurality of memory resources and/or a plurality of memory resource portions.

The bit string arbiter component 113 can be configured to write a second bit string to a second memory rank of the first memory bank among the plurality of memory banks. Similar to writing the first bit string to the first memory rank of the first memory bank, the bit string arbiter component 113 can write the second bit string to a second memory rank of the first memory bank. That is, the bit string arbiter component 113 can write the second bit string to a second memory resource and/or a second portion of the first memory bank. In some embodiments, the first bit string and the second bit string are written sequentially. As used here, the term sequentially refers to actions that are performed without an intervening action being performed.

In some embodiments, the first bit string and the second bit string are written to the first rank and the second rank of the first memory bank among the plurality of memory banks prior to a third bit string being written to a second memory bank among the plurality of memory banks. In some embodiments, the first bit string is written to the first rank and the second bit string is written to the second rank without an intervening bit string being written to a different memory bank (e.g., second memory bank, etc.). For example, the first bit string can be written to the first rank during a first clock cycle and the second bit string can be written to the second rank during a second clock cycle. In this example, the first clock cycle and the second clock cycle can be sequential clock cycles such that there is not an intervening clock cycle that occurs between the first clock cycle and the second clock cycle.

In some embodiments, the first memory rank of the first memory bank and the second memory rank of the first memory bank are associated with a first rank pipeline. As described further herein, the plurality of memory ranks of a memory bank can be communicatively connected through corresponding pipelines. As used herein, a “pipeline” or “data pipeline” that refers to a connection where the output of a first element is an input of a second element. For example, a pipeline can exist between a bank controller and a memory rank of a corresponding bank associated with the bank controller. In this way, the bank controller can provide bit strings to be written to the memory rank through the pipeline. As described further herein, the pipelines can be designated with a corresponding rank and/or a portion of the pipelines can be designated with a corresponding rank. For example, a portion of the pipeline to the first rank can be the same as the pipeline to the second rank. In this example, the portion of the pipeline can have the same rank.

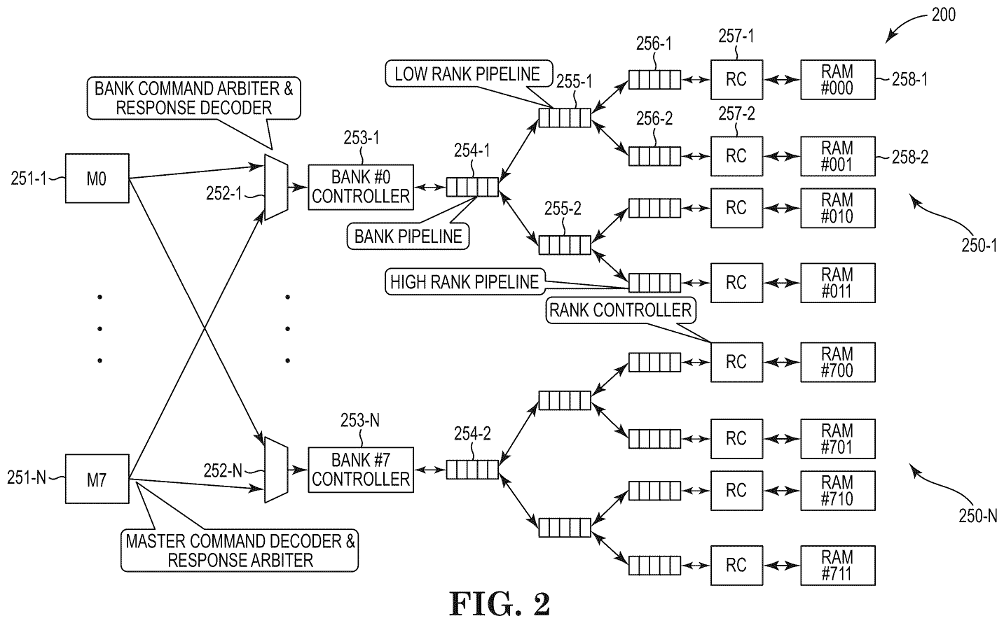

In some embodiments, the first memory rank of the first memory bank and the second memory rank of the first memory bank are associated with a same bank command arbiter. As illustrated further herein with reference to FIG. 2, the same bank command arbiter can be utilized to provide the first bit string and the second bit string to be written to the first memory rank and the second memory rank respectively. As described further herein, the bank command arbiter can provide the first bit string and the second bit string to the bank controller of the first memory bank such that the first bit string is written to the first rank during a first clock cycle and the second bit string is written to the second rank during a second clock cycle.

In some embodiments, the first bit string is received at the controller from a first master command decoder and the second bit string is received at the controller from a second master command decoder. As described herein, the plurality of memory banks can receive requests from a host through a plurality of master command decoders. In some embodiments, the memory sub-system 110 can include a bank command arbiter to receive a plurality of bit strings from the plurality of master command decoders and provide the plurality of bit strings to a corresponding bank controller to be written to the plurality of memory banks. In some embodiments, a first master command decoder can send the first bit string to a first arbiter associated with the first bank controller. In this example, a second master command decoder can send the second bit string to the first arbiter associated with the first bank controller. In this way, different master command decoders can provide sequential requests such as sequential bit strings to the same arbiter and the arbiter can provide the sequential bit strings to the same bank controller of a particular memory bank to be written or read to ranks or particular memory resources of the particular memory bank.

In some embodiments, the first bit string is received at the controller and the second bit string is received at the controller prior to the controller receiving an intervening bit string. As described herein, the first bit string and the second bit string can be sequential bit strings. For example, logical and/or physical addresses associated with the first bit string and the second bit string can be sequential such that an intervening logical and/or physical address is located between the first bit string and the second bit string. In this way, an intervening bit string (or a bit string that is addressed to an intervening address space) is not received during a time between when the first bit string is received and when the second bit string is received. In some embodiments, a third bit string (e.g., intervening bit string, etc.) is not written to a memory rank of the first bank or to a memory rank of any other bank of the memory sub-system 110. Thus, in some embodiments, a bit string can be written to a memory rank of the first memory bank during each clock cycle over a period of clock cycles. As described herein, some previous approaches would alternate writing bit strings to a memory bank such that only half of the clock cycles were utilized to write bit strings over the period of clock cycles.

The bit string arbiter component 113 can be configured to assign the one or more respective memory ranks to the plurality of memory banks. In these embodiments, the one or more respective memory ranks are assigned to the plurality of memory banks such that each of the plurality of memory banks includes a unique memory rank. As described herein, the memory rank is utilized to ensure that a particular memory rank is not provided with a bit string during sequential clock cycles. The bit string arbiter component 113 can ensure that the sequential bit strings (e.g., first bit string and second bit string, etc.) are not written to the same portion or memory rank of the memory bank by utilizing the unique memory ranks of the memory bank.

FIG. 2 illustrates a memory system 200 for bit string arbiters in accordance with some embodiments of the disclosure. The memory system 200 illustrates a plurality of memory banks 250-1, . . . , 250-N. As described herein, the plurality of memory banks 250-1, . . . , 250-N can each include a plurality of memory resources (e.g., memory ranks 258-1, 258-2 associated with memory bank 250-1, etc.). In some embodiments, the memory system 200 includes a plurality of master command decoders 251-1, . . . , 251-N that can provide requests from a host (e.g., the host 120 of FIG. 1) to a plurality of arbiters 252-1, . . . , 252-N.

As described herein, the plurality of arbiters 252-1, . . . , 252-N can be utilized to determine an order for requests to be passed to one of the plurality of memory ranks of a corresponding memory bank. For example, the arbiter 252-1 can receive requests from the master command decoders 251-1, . . . , 251-N and provide the requests to the bank controller 253-1. In a similar way, the arbiter 252-N can receive requests from the master command decoders 251-1, . . . , 251-N and provide the requests to the bank controller 253-N. In some embodiments, the memory system 250 includes a plurality of master command decoders 251-1, . . . , 251-N to generate the first set of corresponding bit strings and the second set of corresponding bit strings. As described herein, the plurality of arbiters 252-1, . . . , 252-N can provide sequential bit strings to a bank controller of the plurality of bank controllers 253-1, . . . , 253-N received from the master command decoders 251-1, . . . , 251-N.

In a specific non-limiting example, the bank controller 253-1 can be connected to a first memory rank 258-1 through a first data pipeline 256-1 and connected to a second memory rank 258-2 through a second data pipeline 256-2. In some embodiments, the first memory rank 258-1 can be associated with a first rank controller 257-1 and the second memory rank 258-2 can be associated with a second rank controller 257-2. As used herein, a “rank controller” refers to a controller that can control functions associated with a particular memory rank. For example, the first rank controller 257-1 can control functions for the first memory rank 258-1 and the second rank controller 257-2 can control functions for the second memory rank 258-2.

In some embodiments, the input of the first data pipeline 256-1 and the input of the second data pipeline 256-2 can be connected to a first portion of a pipeline 255-1 that can be connected to an output of an initial bank pipeline 254-1. In these embodiments, the initial bank pipeline 254-1 can have an input connected to an output of the bank controller 253-1 and the initial bank pipeline 254-1 can have an output connected to the first portion of a pipeline 255-1 and a second portion of a pipeline 255-2. This type of pipeline architecture can be utilized by each of the plurality of memory banks 250-1, . . . , 250-N. For example, the memory bank 250-N can include a bank controller 253-N that has an output connected to the initial bank pipeline 254-2. In this way, the initial bank pipeline 254-2 can include an output connected to a plurality of portions of a pipeline that are each connected to a corresponding data pipeline that are each connected to a memory rank.

In a specific example, the master command decoder 251-1 can provide a first bit string to the arbiter 252-1. In this example, the master command decoder 251-N can provide a second bit string to the arbiter 252-1. In this example, the arbiter 252-1 can provide the first bit string through the initial bank pipeline 254-1, and through the first portion of the pipeline 255-1, through the first data pipeline 256-1 to be written to the memory rank 258-1 during a first clock cycle. In this example, the arbiter 252-1 can provide the second bit string through the initial bank pipeline 254-1, and through the first portion of the pipeline 255-1, through the second data pipeline 256-2 to be written to the memory rank 258-2 during a second clock cycle. In this example, the first clock cycle and the second clock cycle can be sequential clock cycles with no subsequent clock cycles between the first clock cycle and the second clock cycle.

Said differently, the memory system 200 includes a first bank controller 253-1 to provide a first set of corresponding bit strings to a first plurality of non-volatile memory devices utilizing a first set of communication pipelines. In addition, the memory system 200 includes a second bank controller 253-N to provide the second set of corresponding bit strings to the second plurality of non-volatile memory devices utilizing a second set of communication pipelines. Furthermore, the memory system 200 includes a plurality of rank controllers (e.g., rank controllers 257-1, 257-2, etc.) to control functions associated with corresponding ranks within a particular memory bank.

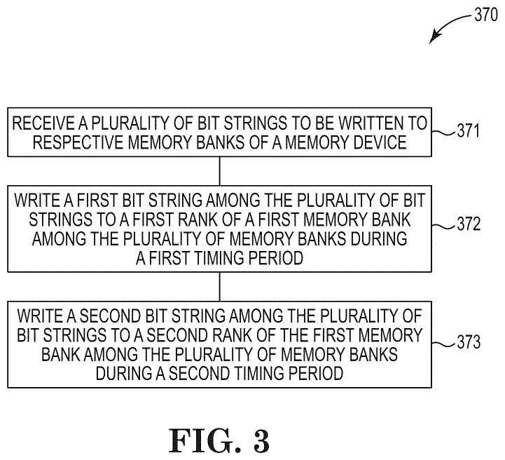

FIG. 3 illustrates a method 370 for performing arbitration of bit strings in accordance with some embodiments of the disclosure. The method 370 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 370 is performed by the bit string arbiter component 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 371, the method 370 can be executed to receive a plurality of bit strings to be written to respective memory banks of a memory device. As described herein, the plurality of bit strings can be received by an arbiter or bit string arbiter component 113 of FIG. 1. The plurality of bit strings can be provided to the arbiter by a host or master command decoder. The plurality of bit strings can be received in a chronological order and identified as being received in the chronological order by the arbiter. In some examples, the chronological order can be utilized to execute particular arbitration rules associated with the memory device.

At operation 372, the method 370 can be executed to write a first bit string among the plurality of bit strings to a first rank of a first memory bank among the plurality of memory banks during a first timing period. As described herein, the first rank can refer to a first memory resource or portion of memory resources within the first memory bank or designated as part of the first memory bank. As described herein, the first rank or first rank value assigned to a memory resource can be utilized by the arbiter to identify an order of writing sequential bit strings to the ranks of the first memory bank. In this way, the first bit string is written to a first rank or memory resources associated with the first rank value and a subsequent bit string is written to a different rank (e.g., the second memory resource, etc.) of the first memory bank. This can prevent the same rank from being written to during sequential clock cycles.

At operation 373, the method 370 can be executed to write a second bit string among the plurality of bit strings to a second rank of the first memory bank among the plurality of memory banks during a second timing period. The second bit string can be a separate bit string from the first bit string. In some embodiments, the first bit string can be provided by a first master command decoder and the second bit string can be provided by a second master command decoder. The first bit string and the second bit string can be sequential bit strings. The second bit string can be written at the second timing period and the first bit string can be written at the first timing period. In some examples, the first timing period is a first clock cycle and the second timing period is a second clock cycle. In these examples, the first clock cycle and the second clock cycle can be sequential clock cycles with no intervening clock cycles between the first clock cycle and the second clock cycle.

In some embodiments, the method 370 can be executed to write the first bit string to the first rank of the first memory device and write the second bit string to the second rank of the first memory device prior to writing an intervening bit string to a second memory bank. In some embodiments, the method 370 can be executed to perform an arbitration operation using an arbitration circuit coupled to the memory device to control the writing of the first bit string to the first rank of the first memory device and the writing of the second bit string to the second rank of the first memory device prior to writing an intervening bit string to a second memory bank.

In some embodiments, the method 370 can be executed to write a third bit string among the plurality of bit strings to a first rank of a second memory bank among the plurality of memory banks during a second timing period. In some embodiments, the method 370 can be executed to write a fourth bit string among the plurality of bit strings to a second rank of the second memory bank among the plurality of memory banks during the second timing period. In some embodiments, the method 370 can be executed to write the third bit string and the fourth bit string to the first and second ranks of the second memory bank subsequent to writing the first bit string and the second bit string to the first and second ranks of the first memory bank. In this way, the third bit string and fourth bit string can be sequentially written to the second memory bank in a similar way as the first bit string and second bit string were written to the first memory bank.

In some embodiments, the method 370 can be executed to write the first bit string through a first rank pipeline and write the second bit string through the first rank pipeline. As illustrated in FIG. 2, the initial bank pipeline can be split into a first portion pipeline with a first rank and a second portion pipeline with a second rank. In this way, the first memory rank and the second memory rank can be connected to the bank controller through the same portion pipeline with a particular rank. In some embodiments, the same portion pipeline can be split to independently connect an output of the portion pipeline with the particular pipeline rank to the first rank and the second rank.

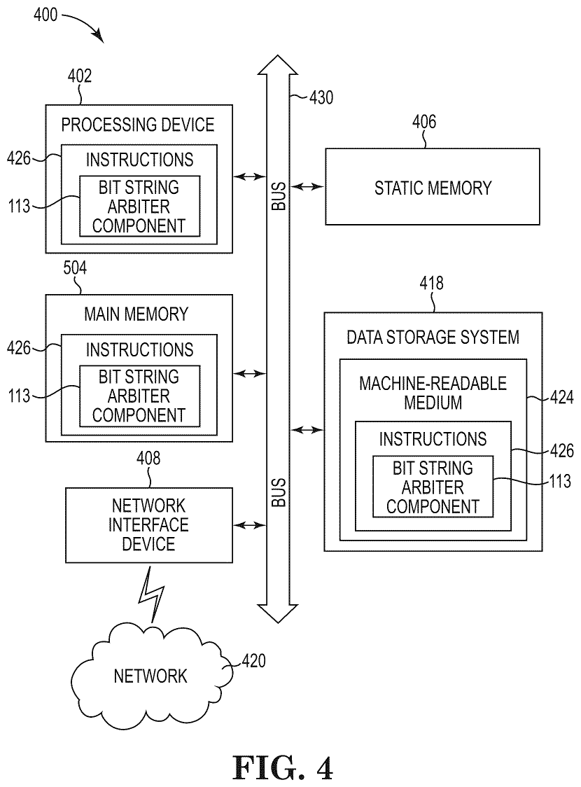

FIG. 4 is a block diagram of an example computer system 400 in which embodiments of the disclosure may operate. For example, FIG. 4 illustrates an example machine of a computer system 400 within which a set of instructions, for causing the machine to perform any one or more of the methodologies discussed herein, can be executed. In some embodiments, the computer system 400 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the sensing time component 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 400 includes a processing device 402, a main memory 404 (e.g., read-only memory (ROM), flash memory, dynamic random access memory (DRAM) such as synchronous DRAM (SDRAM) or Rambus DRAM (RDRAM), etc.), a static memory 406 (e.g., flash memory, static random access memory (SRAM), etc.), and a data storage system 418, which communicate with each other via a bus 430.

The processing device 402 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. The processing device 402 can also be one or more special-purpose processing devices such as an application specific integrated circuit (ASIC), a field programmable gate array (FPGA), a digital signal processor (DSP), network processor, or the like. The processing device 402 is configured to execute instructions 426 for performing the operations and steps discussed herein. The computer system 400 can further include a network interface device 408 to communicate over the network 420.

The data storage system 418 can include a machine-readable storage medium 424 (also known as a computer-readable medium) on which is stored one or more sets of instructions 426 or software embodying any one or more of the methodologies or functions described herein. The instructions 426 can also reside, completely or at least partially, within the main memory 404 and/or within the processing device 402 during execution thereof by the computer system 400, the main memory 404 and the processing device 402 also constituting machine-readable storage media. The machine-readable storage medium 424, data storage system 418, and/or main memory 404 can correspond to the memory sub-system 110 of FIG. 1.

In one embodiment, the instructions 426 include instructions to implement functionality corresponding to a bit string arbiter component (e.g., the bit string arbiter component 113 of FIG. 1). While the machine-readable storage medium 424 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

In some embodiments, the bit string arbiter component 113 can be executed to determine a first arbiter order for a first memory bank based on a first set of rank values of a first plurality of non-volatile memory devices within the first memory bank. As used herein, a “rank value” refers to a value associated with a particular rank of a memory bank. In this way, the rank value can be utilized to identify a particular rank of the memory bank from a plurality of other ranks of the memory bank. As used herein, an “arbiter order” refers to an order of writing bit strings to a plurality of memory ranks. For example, each of the plurality of memory ranks can be assigned a rank value to identify the arbiter order to perform write operations on the plurality of memory resources of the ranks.

In some embodiments, the bit string arbiter component 113 can be executed to provide a first set of corresponding bit strings to each of the first plurality of non-volatile memory devices within the first memory bank based on the first arbiter order. In some embodiments, the first set of bit strings include a plurality of bit strings that are sequential bit strings provided to the first memory bank prior to providing intervening bit strings. As described herein, a set of sequential bit strings can be provided to a bank controller of the first memory bank by an arbiter. The arbiter can receive the set of bit strings from one or more master command decoders and organize the set of bit strings to be provided sequentially to the plurality of memory ranks during each clock cycle of a plurality of clock cycles. As described herein, the arbiter order can ensure that a single memory rank from the memory bank is not written to during sequential clock cycles.

In some embodiments, the bit string arbiter component 113 can be executed to determine a second arbiter order for a second memory bank based on a second set of rank values of a second plurality of non-volatile memory devices within the second memory bank. As described herein, a plurality of memory banks can each be organized into ranks and each rank can include an assigned rank value. In this way, the second memory bank can include a plurality of ranks that can be assigned rank values and the second arbiter order can be determined based on the assigned rank values for ranks of the second memory bank. The second arbiter order can be separate and/or not based on the first arbiter order. In this way, the first memory bank can utilize a first arbiter and the second memory bank can utilize a second arbiter that may not be in communication with the first arbiter.

In some embodiments, the bit string arbiter component 113 can be executed to provide, in response to providing a corresponding bit string to a last non-volatile memory device from the first plurality of non-volatile memory devices, a second set of corresponding bit strings to each of the second plurality of non-volatile memory devices within the second memory bank based on the second arbiter order. As described herein, an arbiter order can be utilized to sequentially write bit strings to the plurality of memory resources associated with a rank of a memory bank until an end of the arbiter order or until each of the plurality of ranks of the memory bank have had a write operation performed. In these embodiments, the arbiter can return to a start of the arbiter order and continue through the arbiter order.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer readable storage medium, such as, but not limited to, any type of disk including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer).

In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory devices, etc. In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A method, comprising:
receiving a plurality of bit strings to be written to respective memory banks of a memory device;
writing a first bit string among the plurality of bit strings to a first rank of a first memory bank among the plurality of memory banks during a first timing period; and
writing a second bit string among the plurality of bit strings to a second rank of the first memory bank among the plurality of memory banks during a second timing period.

2. The method of claim 1, further comprising writing the first bit string to the first rank of the first memory bank and writing of the second bit string to the second rank of the first memory bank prior to writing an intervening bit string to a second memory bank.

3. The method of claim 1, further comprising performing an arbitration operation using an arbitration circuit coupled to the memory device to control the writing of the first bit string to the first rank of the first memory bank and the writing of the second bit string to the second rank of the first memory bank prior to writing an intervening bit string to a second memory bank.

4. The method of claim 1, further comprising:
writing a third bit string among the plurality of bit strings to a first rank of a second memory bank among the plurality of memory banks during a second timing period; and
writing a fourth bit string among the plurality of bit strings to a second rank of the second memory bank among the plurality of memory banks during the second timing period.

5. The method of claim 4, further comprising writing the third bit string and the fourth bit string to the first and second ranks of the second memory bank subsequent to writing the first bit string and the second bit string to the first and second ranks of the first memory bank.

6. The method of claim 1, wherein writing the first bit string to the first rank of the first memory bank includes writing the first bit string through a first rank pipeline and wherein writing the second bit string to the second rank of the first memory bank includes writing the second bit string through the first rank pipeline.

7. The method of claim 1, wherein writing the first bit string to the first rank of the first memory bank includes writing the first bit string through a first rank pipeline and wherein writing the second bit string to the second rank of the first memory bank includes writing the second bit string through the first rank pipeline.

8. An apparatus, comprising:
a plurality of memory banks each comprising one or more respective memory ranks;
a controller coupled to the plurality of memory banks, wherein the controller is configured to:
write a first bit string to a first memory rank of a first memory bank among the plurality of memory banks; and
write a second bit string to a second memory rank of the first memory bank among the plurality of memory banks, wherein:
the first bit string and the second bit string are written to the first rank and the second rank of the first memory bank among the plurality of memory banks prior to a third bit string being written to a second memory bank among the plurality of memory banks.

9. The apparatus of claim 8, wherein the first memory rank of the first memory bank and the second memory rank of the first memory bank are associated with a first rank pipeline.

10. The apparatus of claim 8, wherein the first memory rank of the first memory bank and the second memory rank of the first memory bank are associated with a same bank command arbiter.

11. The apparatus of claim 8, wherein the first bit string is received at the controller from a first master command decoder and the second bit string is received at the controller from a second master command decoder.

12. The apparatus of claim 11, wherein the first bit string is received at the controller and the second bit string is received at the controller prior to the controller receiving an intervening bit string.

13. The apparatus of claim 8, comprising a bank command arbiter to provide a plurality of bit strings to the controller to be written to the plurality of memory banks.

14. The apparatus of claim 8, wherein the controller is further configured to assign the one or more respective memory ranks to the plurality of memory banks.

15. The apparatus of claim 14, wherein the one or more respective memory ranks are assigned to the plurality of memory banks such that each of the plurality of memory banks includes a unique memory rank value.

16. A system comprising:
a memory sub-system comprising a plurality of memory banks comprising a plurality of non-volatile memory devices; and
a processing device coupled to the memory sub-system, wherein the processing device is configured to:
determine a first arbiter order for a first memory bank based on a first set of rank values of a first plurality of non-volatile memory devices within the first memory bank;
provide a first set of corresponding bit strings to each of the first plurality of non-volatile memory devices within the first memory bank based on the first arbiter order;
determine a second arbiter order for a second memory bank based on a second set of rank values of a second plurality of non-volatile memory devices within the second memory bank; and
provide, in response to providing a corresponding bit string to a last non-volatile memory device from the first plurality of non-volatile memory devices, a second set of corresponding bit strings to each of the second plurality of non-volatile memory devices within the second memory bank based on the second arbiter order.

17. The system of claim 16, comprising a plurality of master command decoders to generate the first set of corresponding bit strings and the second set of corresponding bit strings.

18. The system of claim 16, wherein the first set of bit strings include a plurality of bit strings that are sequential bit strings provided to the first memory bank prior to providing intervening bit strings.

19. The system of claim 16, comprising:
a first bank controller to provide the first set of corresponding bit strings to the first plurality of non-volatile memory devices utilizing a first set of communication pipelines; and
a second bank controller to provide the second set of corresponding bit strings to the second plurality of non-volatile memory devices utilizing a second set of communication pipelines.

20. The system of claim 16, comprising a plurality of rank controllers to control functions for the first plurality of non-volatile memory devices with the first set of rank values and the second plurality of non-volatile memory devices with the second set of rank values.
